(19) United States
(12) Patent Application Publication
(10) Pub. No.: US 2012/0307506 A1
(43) Pub. Date: Dec. 6, 2012

(54) FLASHLIGHT HOLDER FOR SCUBA DIVING

(76) Inventor: BUDDY GUNN, Lake Barrington, IL (US)

(21) Appl. No.: 13/365,511

(22) Filed: Feb. 3, 2012

Related U.S. Application Data
(60) Provisional application No. 61/492,001, filed on Jun. 1, 2011.

(51) Int. Cl. F21V 19/00

(52) U.S. Cl. 362/382

(57) ABSTRACT

A flashlight holder may comprise an arm cuff adapted to attach an arm of a user. The arm cuff may have an opening throughout its longitudinal axis. The arm cuff may comprise a flexible material and have affixed thereto means for engaging a flashlight and retaining the flashlight which may be substantially parallel to the arm of the user.

### RELATED APPLICATIONS

The present application claims benefit of U.S. Provisional Application No. 61/492001 filed on Jun. 1, 2011, the entirety of which is incorporated herein by reference.

### BACKGROUND OF THE INVENTION

The present invention relates generally to a flashlight holder and, more specifically, to a flashlight holder that can position a light beam on a subject of interest while leaving users hands free.

Many different professions require uses of a flashlight for visibility in a dark environment. Examples of persons employing flashlights while on the job include law enforcement officers, inspectors, automobile mechanics, and exterminators. Likewise, persons engaged in various outdoor activities such as camping also frequently require a readily available flashlight. In particular, people scuba dive at night may need flashlight to navigate the perils of being underwater.

However, it is inconvenient to manually hold a flashlight for long periods of time because one hand must be dedicated to the flashlight.

Therefore, it can be seen that there is a need for flashlight holding apparatus that maintains a flashlight in a readily accessible position about one's arm while leaving the hands of a user free to grasp tools and the like.

### SUMMARY OF INVENTIONS

In one aspect, a flashlight holder comprises an arm cuff adapted to attach to an arm of a user; wherein the arm cuff has an opening throughout its longitudinal axis, wherein the arm cuff comprises a flexible material, wherein the arm cuff has affixed thereto means for engaging a flashlight and retaining the flashlight substantially parallel to the arm of the user.

In another aspect, a flashlight holder comprises a flashlight cradle; an adjustable member coupled to the flashlight cradle; and an arm cuff coupled to the flashlight cradle, wherein the arm cuff is adapted to receive an arm of a user.

These and other features, aspects and advantages of the present invention will become better understood with reference to the following drawings, description and claims.

### BRIEF DESCRIPTION OF THE DRAWINGS

FIG. 1 is a perspective view of an arm mountable flashlight holder according to an exemplary embodiment of the present invention in use;

FIG. 2 is a perspective view of an arm mountable flashlight holder according to an exemplary embodiment of the present invention;

FIG. 3 is an exploded view of an arm mountable flashlight holder according to an exemplary embodiment of the present invention.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments comprise a flashlight holder. More specifically, exemplary embodiments of the present invention provide a flashlight holder that can position a light beam on a subject of interest while leaving users hands free.

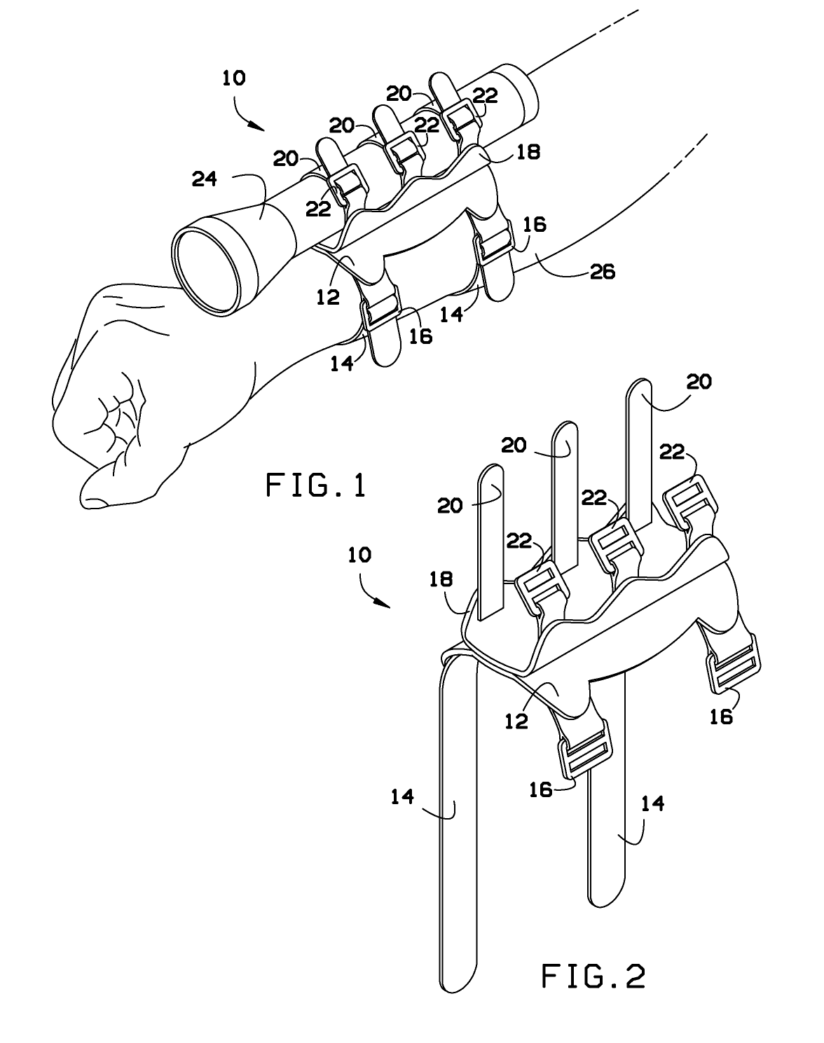

Referring to FIGS. 1-2, a flashlight holder 10 may comprise a flashlight cradle 18 and an arm cuff 12. The arm cuff 12 may have arm straps 14 and strap buckles 16, which may be adapted to receive an arm 26 of a user. The arm cuff 12 may be coupled to the flashlight cradle 18 by sewing, for example. The arm cuff 12 may have one opening throughout its longitudinal axis. The arm cuff 12 and the flashlight cradle 18 may comprise a flexible material. The flexible material may be cloth, webbing material, leather, vinyl, neoprene, and plastic, for example.

The arm cuff 12 may have affixed thereto means for engaging a flashlight 24 and retaining the flashlight 24 substantially parallel to the arm 26 of the user. The means for engaging a flashlight may comprise a pair of straps 20.

Each of pair of straps 20 may be an adjustable member and may have a first end and a second distal end. Each of the first ends may be affixed to the arm cuff 12 and the pair of the second distal ends joined to one another by a fastening means to form at least one loop.

The arm cuff 12 may be a flat and flexible cover layer that bends around the user's arm providing a base for the cylinder light to rest in a secured position. The light beam may shine in the direction aligned to the user's forearm past the user's hand. The light holder may release the light as directed by the user. The light holder may be adjusted to fit the user's forearm.

The fastening means may comprise a hook-and-loop system, such as Velcro®, for example. Alternatively, the fastening means may comprise an over center latch or a strap-and-buckle system, such as a strap buckles 22 being used, for example.

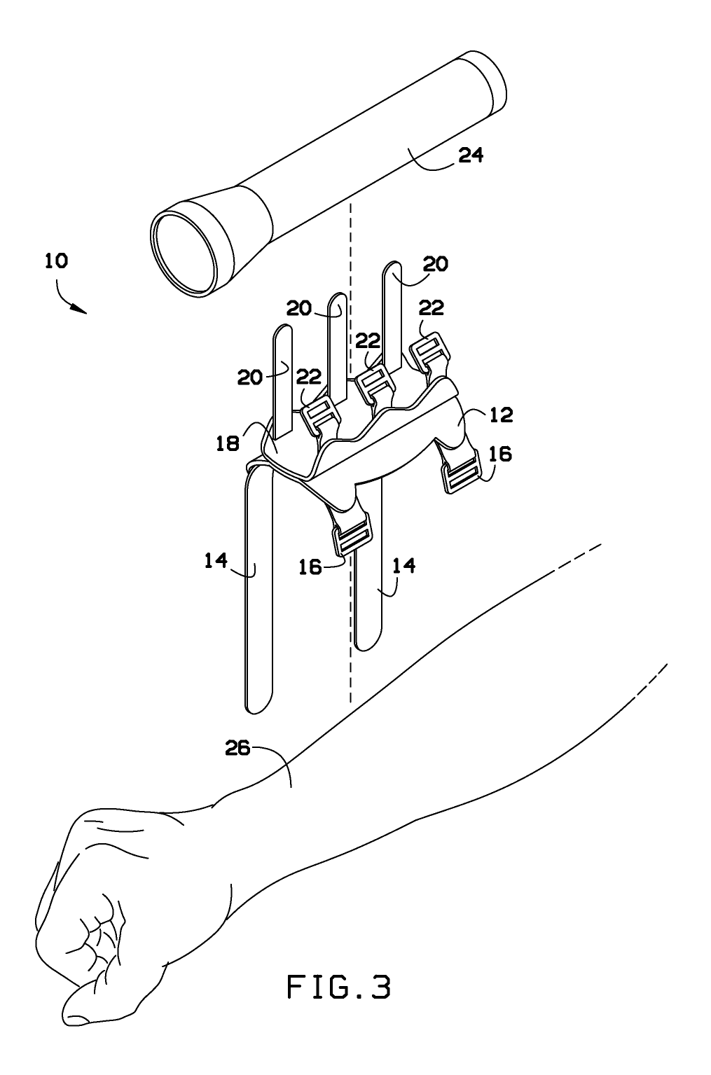

As shown in FIG. 3, the light may be held securely in the position because straps wrap around the light holding it in a rigid position. The straps may produce a binding tension around the light anchoring the light to the material cover layer wrapped around the user's forearm. The light is secured in the position parallel to the user's forearm, which may send the light beam in the direction the forearm is pointing toward.

The light may maintain the position until the time it is released from the secured position by the user. The method to remove the light from the flashlight holder is to open the fastening straps connecting the light holding device to the user's arm. The user may have option of setting the fastening straps that hold the light device to the user's arm.

This may be accomplished by adjusting the straps fastening locations that close the light holding device, which creates the proper fit to maintain the light holding device on the user's forearm. The light maintains a steady position on the user's arm because of a combined result of the material holder wrapped around the user's arm and the material strapping device locked to the user's arm.

To make an exemplary embodiment of the present invention, users may have to make an arm cuff and connect the arm cuff with connecting straps. Users may use two sets of connecting straps, one adjusting for the user's forearm and being controlled by buckles, with the other set adjusting for cylindrical light circumference and being held by buckles.

Users may use an exemplary embodiment of the present invention by putting the invention on the forearm, securing appropriate straps, placing the flashlight in the designated spot and securing the straps for it as well. Then users may turn the flashlight on and do what users need hands free.

It should be understood, of course, that the foregoing relate to exemplary embodiments of the invention and that modifications may be made without departing from the spirit and scope of the invention as set forth in the following claims.

We claim:

1. A flashlight holder, comprising:
an arm cuff adapted to attach to an arm of a user; wherein the arm cuff has an opening throughout its longitudinal axis, wherein the arm cuff comprises a flexible material, wherein the arm cuff has affixed thereto means for engaging a flashlight and retaining the flashlight substantially parallel to the arm of the user.

2. The flashlight holder of claim 1, wherein the flexible material comprises at least one of cloth, webbing material, leather, vinyl, neoprene, and plastic.

3. The flashlight holder of claim 1, wherein the means for engaging a flashlight comprises a pair of straps, each having a first end and a second distal end, each the first end being affixed to the arm cuff and the pair of the second distal ends joined to one another by a fastening means to form at least one loop.

4. The flashlight holder of claim 3, wherein the fastening means comprises a hook-and-loop system.

5. The flashlight holder of claim 1, wherein the fastening means comprises a strap-and-buckle system.

6. The flashlight holder, comprising:
a flashlight cradle;
an adjustable member coupled to the flashlight cradle; and
an arm cuff coupled to the flashlight cradle, wherein the arm cuff is adapted to receive an arm of a user.

7. The flashlight holder of claim 6, further comprising a fastening member configured to fasten the arm cuff to the arm of the user.

8. The flashlight holder of claim 7, wherein the fastening member further comprises one of a hook fastener, a loop fastener, a buckle, or an over center latch.

9. The flashlight holder of claim 6, wherein the adjustable member further comprises one of a hook fastener, a loop fastener, a buckle, or an over center latch.

10. The flashlight holder of claim 7, wherein the flashlight cradle is configured to retain a flashlight substantially parallel to the arm of the user.
